(19) United States
(12) Patent Application Publication
(10) Pub. No.: US 2017/0358908 A1
(43) Pub. Date: Dec. 14, 2017

(54) SYSTEM AND METHOD FOR ELECTRICAL INFRASTRUCTURE MAINTENANCE

(71) Applicant: ULC ROBOTICS, INC., Hauppauge, NY (US)

(72) Inventors: George LOHR, Commack, NY (US); Robert E. KODADEK, III, Long Beach, NY (US)

(21) Appl. No.: 15/622,725

(22) Filed: Jun. 14, 2017

Related U.S. Application Data
(60) Provisional application No. 62/349,736, filed on Jun. 14, 2016.

(51) Int. Cl. H02G 1/00

(52) U.S. Cl. CPC H02G 1/00

(57) ABSTRACT

A system for electrical infrastructure maintenance includes a cutter arrangement configured for insertion into an electrical conduit and operable to cut around at least a portion of a perimeter of an electrical cable disposed within the conduit. A gripper arrangement is operable to capture a portion of the electrical cable, and a motor arrangement may be used to rotate and move linearly the cutter arrangement and the gripper arrangement.

### CROSS-REFERENCE TO RELATED APPLICATIONS

This application claims the benefit of U.S. provisional application Ser. No. 62/349,736 filed Jun. 14, 2016, which is hereby incorporated herein by reference in its entirety.

### TECHNICAL FIELD

The present disclosure relates to a system and method for electrical infrastructure maintenance.

### BACKGROUND

In order to provide electrical service to residential and commercial customers, electrical cables may be routed from an underground service box to a customer meter. The cables may be encased in concrete, fiber, or wood ducts that are connected to steel pipes or conduits. During operation any number of issues may arise, sometimes resulting in the outer, insulating jacket of the electrical cable being damaged. When this happens, a short-circuit may be created, which can cause some or all of the electrical conductors within the cables to be fused to each other, fused to the conduit wall, or both. Removing the damaged cables can be difficult if one or more of them is fused solidly to the wall of the conduit: the bond between the cables and the conduit may be difficult to break, and during the attempt, it is not uncommon for the cables themselves to break. Even where no fusing occurs, cables may break and it may be difficult or impossible to remove them because of the small inner diameter of the pipe. This may lead to only a portion of the cables being removed, with another portion remaining within the conduit. Therefore, a need exists for a system and method for removing cables from an electrical conduit that overcomes some or all of the problems of current systems and methods.

### SUMMARY

At least some embodiments described herein may include a system and method for locating a potential defect within an electrical conduit without trenching the entire length of the pipe. When the defect is a fused cable, the bond may be broken from inside the pipe and the remaining cable removed. At least some embodiments provide a system and method that enters an open end of a buried steel conduit, which is accessed through an excavation pit or interior wall opening. The interior of the conduit is traversed until the fused cable is located from inside the pipe. The fused portion is broken, ground, or otherwise freed-up, and the cable is then gripped and removed from the conduit. In some cases, it may be necessary for the system and method to remove additional obstructions from the conduit, for example, by vacuuming rocks, dirt, and the like so that new cable can be installed.

At least some embodiments described herein may include a system for electrical infrastructure maintenance that includes a cutter arrangement configured for insertion into an electrical conduit and operable to cut around at least a portion of an electrical cable disposed within the conduit. The electrical cable may include one or more electrical conductors, such as a single-piece, solid conductor, or a multi-piece, stranded conductor. As used herein, the word “maintenance” can include repair maintenance, preventative maintenance, rehabilitation, the installation of new systems or components, or any combination of these. A gripper arrangement is operable to capture a portion of the electrical cable, and a motor arrangement may be used to rotate and move linearly the cutter arrangement and the gripper arrangement.

In at least some embodiments, the cutter arrangement may include a circumferential cutter having a front portion with cutting teeth disposed around a circumference and a rear portion having an aperture disposed therethrough for allowing the electrical cable to pass through. In at least some embodiments, the gripper arrangement may include a plurality of threads disposed on an inside portion thereof such that the threads grip the at least one of the at least one electrical conductor when the gripper arrangement is rotated by the motor arrangement. The system may further include a support structure having the motor arrangement mounted thereon such that the motor arrangement is vertically adjustable on the support structure. Additionally, components of the system—e.g., a cutter, gripper, support structure, etc.—may be used together or separately to perform various tasks. For example, a gripper may be used without a cutter in a configuration if a cutter is not needed to cut the cable from the wall of a conduit but the gripper is needed to grab the cable.

At least some embodiments described herein include a system for electrical infrastructure maintenance that includes a tool head including a rotationally-actuated cutter and a gripper, the tool head being operable to cut around at least a portion of an electrical cable disposed within a conduit, and further operable to secure the electrical cable therein. A motor arrangement is operable to rotate the tool head for cutting and securing the electrical cable.

At least some embodiments described herein include a method for electrical infrastructure maintenance, including the step of cutting around an outside of an electrical cable adhered to an inside wall of a conduit with a cutter arrangement to detach the electrical cable from the inside wall of the conduit. The method may also include securing an end of the electrical cable with a gripper arrangement after the electrical cable is detached from the inside wall of the conduit, and pulling the electrical cable from the conduit after the end of the electrical cable is secured with the gripper arrangement.

### BRIEF DESCRIPTION OF THE DRAWINGS

FIG. 1 shows a system for electrical infrastructure maintenance in accordance with an embodiment described herein;

FIG. 2 shows a portion of the system shown in FIG. 1;

FIG. 3 shows an alternative configuration for the system shown in FIG. 1;

FIG. 4 shows a tool head making up a portion of the system shown in FIG. 1;

FIG. 5 shows an exploded view of the tool head shown in FIG. 4;

FIG. 6 shows an electrical cable captured by a gripper arrangement forming part of the tool head shown in FIG. 4;

FIG. 7 shows a tool head arrangement attached to a plurality of extension rods for extending the reach of a system in accordance with embodiments described herein;

FIG. 8 shows a universal joint attachable to an extension rod such as illustrated in FIG. 7, which provides angular flexibility for a system in accordance with embodiments described herein; and

FIG. 9 shows an electrical cable fused to the inside of a conduit.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

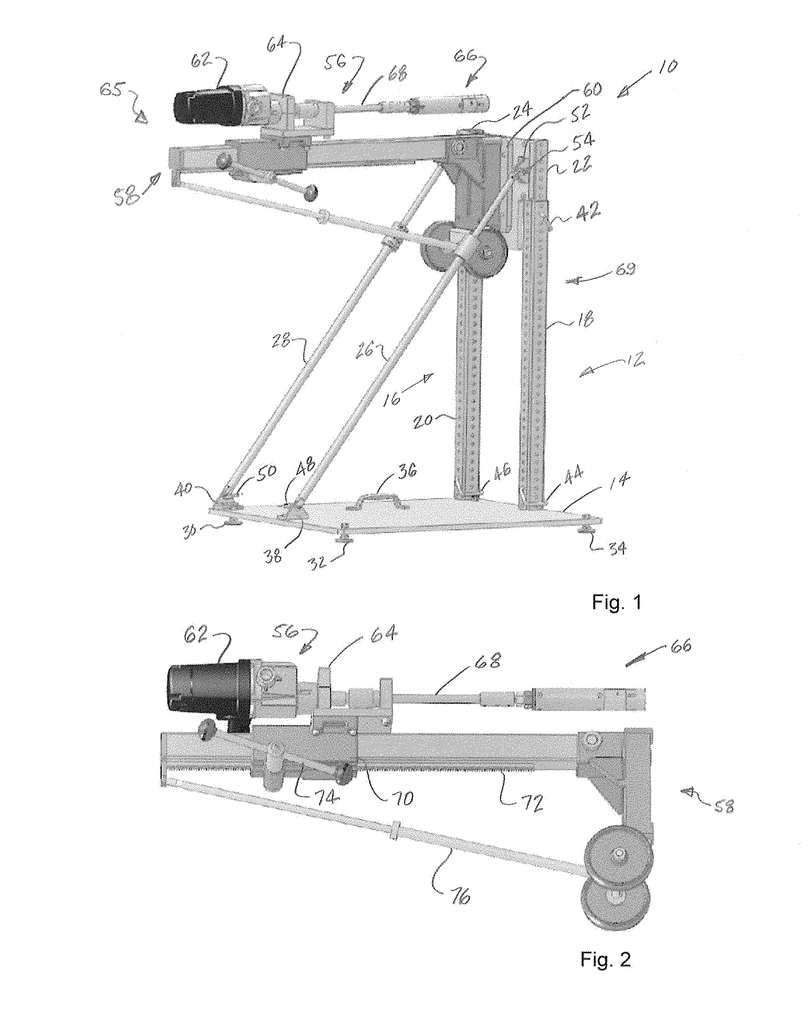

FIG. 1 shows a system 10 for electrical infrastructure maintenance in accordance with at least some embodiments described herein. As a described in more detail below, the system 10 can be used for finding and removing an electrical cable from inside a carrier, such as a conduit. The system 10 includes a support structure 12, which includes a base 14, a generally vertical rail system 16—which includes two stationary rails 18, 20 and two movable rails 22, 24 respectively disposed adjacent to the stationary rails 18, 20—and two angle braces 26, 28. The base 14 may be manufactured from stainless steel, for example, which, in addition to providing good corrosion resistance, also provides significant weight to stabilize the system 10. In the embodiment shown in FIG. 1, the base 14 is large enough for a system operator to stand on it while work is being performed, which may provide additional stability to the system 10 during operation.

The base 14 is shown in FIG. 1 has adjustable feet 30, 32, 34, and although not visible in FIG. 1, it is understood that a fourth adjustable foot is attached to the base 14 near the corner closest to the rail 20. The base 14 also includes a handle 36, which aids in the portability of the system 10. The two angle braces 26, 28 are attached to the base 14 at brackets 38, 40, respectively. The angle braces 26, 28 are telescoping to allow for vertical adjustment between the movable rails 22, 24 and the stationary rails 18, 20. The brackets 38, 40 allow the angle braces 26, 28 to pivot as needed to facilitate the vertical adjustment. The relative position of the movable rails 22, 24 relative to the stationary rails 18, 20 are set using pins, such as the pin 42 shown engaged with the rail 22 and the rail 18. It is understood that a similar pin is engaged with the rails 24 and 20, but which is not visible in FIG. 1. Near the bottom of the rails 18, 20 are two pins 44, 46, which connect the stationary rails 18, 20 to brackets attached to the base 14: the brackets are inside the rails 44, 46 and are therefore not visible in FIG. 1. The pins 42, 44, 46 may be, for example, clevis pens, tab-lock pins, or some other kind of pin or dowel usable to quickly and effectively secure the rails 18, 20, 22, 24.

The angle braces 26, 28 are attached to the brackets 38, 40 with easily removable pins 48, 50, which may be, for example, hairpin cotters or some other easily insertable and removable pin or clip. A similar mounting configuration is used at the tops of the angle braces 26, 28, although in FIG. 1, only the bracket 52 and the removable pin 54 associated with the angle brace 26 are visible. The quick-release mounting features of the angle braces 26, 28, and the handle 36 attached to the base 14, help to improve portability of the system 10, which may be moved from location to location as needed to address electrical problems.

The system 10 also includes a motor assembly 56, which is described in more detail in conjunction with FIG. 2 below. The motor assembly 56 is supported on an angle stand 58, which is attached to the rails 22, 24 via a mounting plate 60. The motor assembly 56 includes a motor 62 attached to a drill support 64, which is connected to the angle stand 58. The motor assembly 56 and the angle stand 58 may be conveniently referred to as a motor arrangement 65, which operates to rotate and move linearly a tool head 66. The tool head 66 is connected to the motor 62 through one or more extension rods 68. This is shown in more detail in FIG. 2, where the angle stand 58 is shown detached from the rails 22, 24 of the floor mount structure 69, which is generally made up of the base 14, the rails 18, 20, 22, 24, the angle braces 26, 28, and the mounting plate 60. The motor 62 is operable to rotate the extension rod 68 and the tool head 66 to free a fused electrical cable from inside a conduit and into grab the end of the cable to facilitate removal from the conduit.

The angle stand 58 includes a movable section 70 which cooperates with a rack 72 to facilitate linear movement of the motor assembly 56 toward and away from a conduit or other problem site. In the embodiment shown in FIG. 2, the movable section 70 may contain one or more pinions—not visible in FIG. 2—which mesh with the rack 72, and which are rotated by rotation of a handle 74. The handle 74 may be manually rotated by a system operator, who can also adjust an angle brace 76 of the angle stand 58 to adjust the entry angle of the tool head 66 into the problem site. Alternatively, the movable section 70 may be actuated by a motor or other mechanized system.

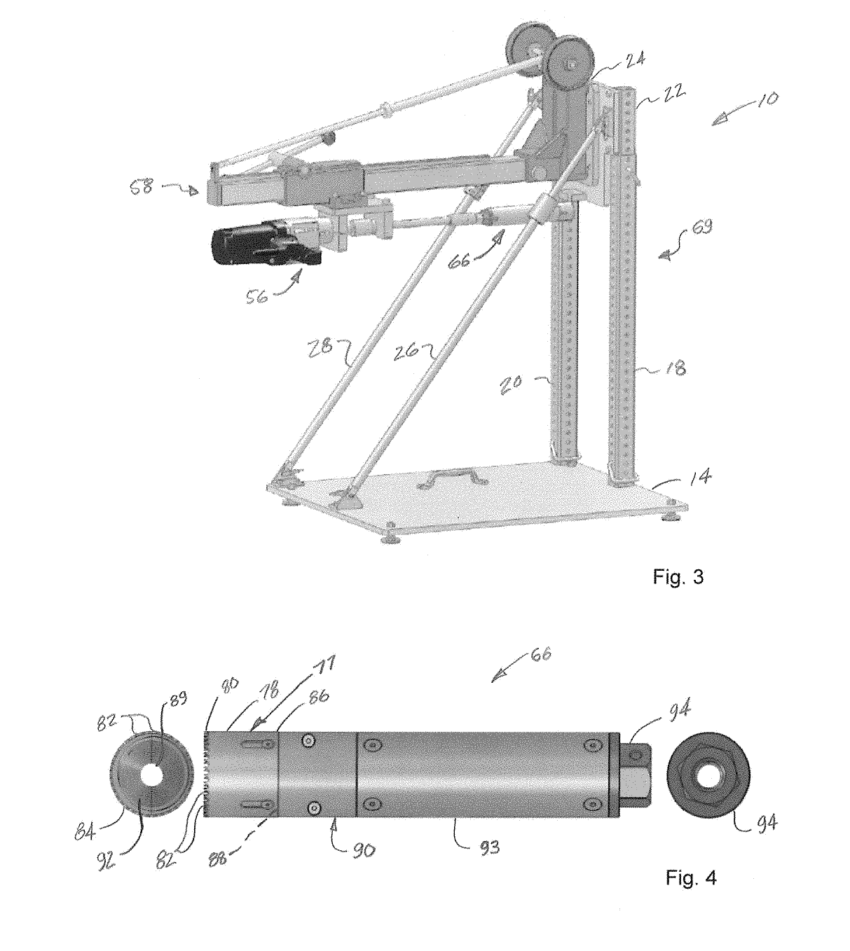

Because the angle stand 58 is removable from the floor mount 69, additional vertical range can be obtained by mounting the angle stand 58 onto the floor mount 69 with an orientation 180° from that which is illustrated in FIG. 1. This configuration is shown in FIG. 3, where the tool head 66 is positioned several inches lower than it is in the orientation shown in FIG. 1, and yet the position of the rails 22, 24 are the same. In at least some embodiments, a configuration utilizing an upward-facing mount, as shown in FIG. 1, may allow the tool head 66 to be used at a height of up to nearly 75 inches. With the downward-facing mount, as shown in FIG. 3, the tool head 66 may be used at a position as low as 30 inches. Of course, different embodiments may include different lengths of rails, such as the rails 18, 20, 22, 24, and this will influence the overall vertical range where a tool head, such as the tool head 66, can be used.

As described above, embodiments may provide a system that includes a cutter arrangement, a gripper arrangement, and a motor arrangement, and which can be used to locate and release a fused electrical cable from inside a conduit, and then facilitate removal of the remaining portion of the cable from the conduit. Additional embodiments include cameras and other sensors, which, for example, may include a device for measuring distance, such as a rotary encoder, to determine a distance the tool has traveled into the conduit. FIG. 4 shows the tool head 66 in greater detail having several of these features described above. The tool head 66 includes a cutter arrangement 77, which, in the embodiment shown in FIG. 4, includes a circumferential cutter 78 having a front portion 80 with cutting teeth 82 disposed around its circumference 84. The circumferential cutter 78 also includes a rear portion 86 having a hole 88 disposed therethrough, which allows an electrical cable to pass through it and reach a gripper arrangement 90.

The gripper arrangement 90 includes a rotationally-actuated gripper 91 having a plurality of threads 92, which are illustrated in the left end-view of FIG. 4. The gripper arrangement 90 includes an aperture 89 disposed therethrough. As shown in FIG. 4, the tool head 66 also includes an extension tube 93, which is configured to receive an extended length of the electrical cable after it passes through the aperture 89 in the gripper arrangement 90. An extension tube, such as the extension tube 93, may be configured in various lengths, and helps to facilitate the cable passing through the gripper into a hollow section of the tool. A driving hub 94 allows the tool head 66 to be rotated by the motor 62, which may be through one or more extension rods, such as the extension rod 68 shown in FIG. 1. In this embodiment, the cutter arrangement 77 and the gripper arrangement 90 are part of the same tool head 66, but in other embodiments, a cutter arrangement and gripper arrangement may be part of separate tool heads. For example, a gripper arrangement may be hand-held and used by an operator manually—i.e., without a motor.

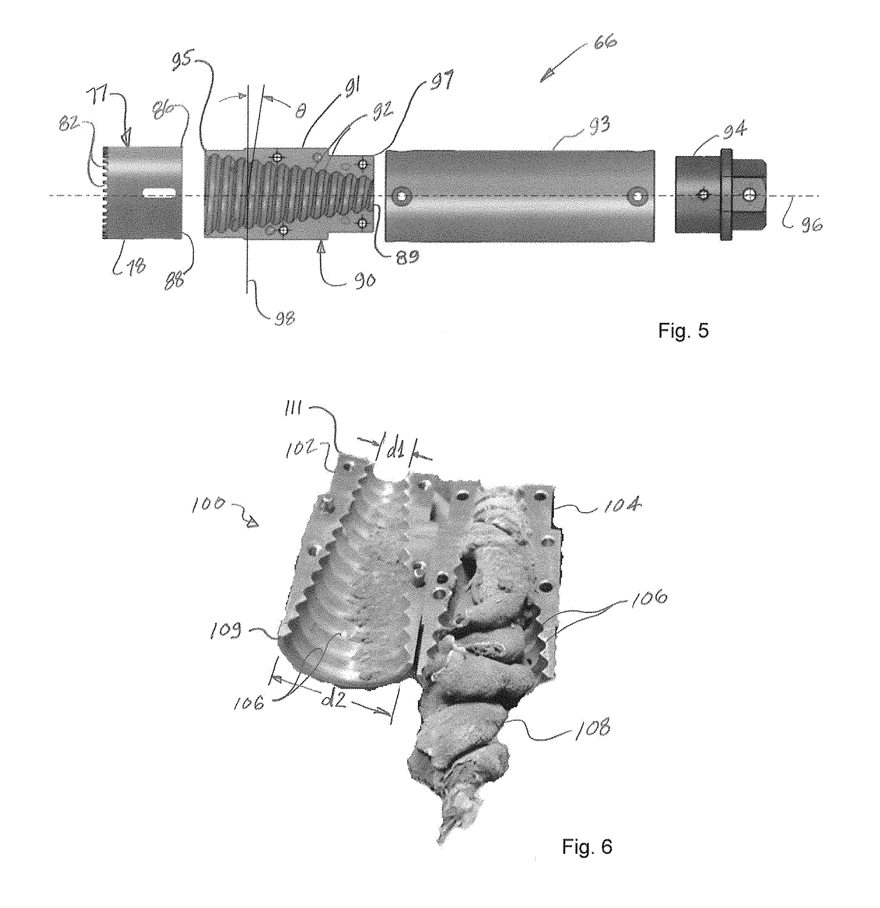

FIG. 5 shows the tool head 66 in an exploded view with the gripper arrangement 90 disassembled so that the internal threads 92 are visible. The gripper arrangement 90 includes a first end 95 and a second end 97; in this embodiment, the first end 95 is disposed closer to the cutter arrangement 77 than the second end 97. As shown in FIG. 5, the circumferential cutter 78 has the aperture 88 through a rear portion 86 to allow an electrical cable to pass through it and into the gripper arrangement 90. As described above, an electrical cable may fuse to the side of a conduit in which it is located, and when this occurs, it may be impossible to remove the cable from the conduit without first breaking the fused cable away from the wall of the conduit. To accomplish this, the tool head 66 is rotated such that the teeth 82 of the circumferential cutter 78 cut through any fused or welded portion of the cable that is bonded to the side of the conduit, thereby freeing the cable for removal.

As shown in FIG. 5, a longitudinal axis 96 is oriented along a length of the tool head 66. A line 98 struck perpendicularly to the axis 96 is illustrated to further define the threads 92 of the gripper arrangement 90. In particular, the threads 92 form an angle θ with the line 98. In the embodiment shown in FIG. 5, the angle θ is approximately 8°; however, in other embodiments the angle formed by the threads in the gripper arrangement may be between 5° and 15°. In other embodiments, the angle of the threads may be steeper or shallower, depending on various considerations, such as manufacturing considerations and the effectiveness of the threads to grab a cable inside a conduit. In this embodiment, the gripper 91 is rotationally actuated; however, in other embodiments, a gripper arrangement may include a gripper that is not rotationally actuated. For example, a gripper may include a series of teeth angled away from an opening; this allows an end of an electrical cable to be inserted linearly into the opening where it engages with the angled teeth. When the gripper is pulled in a direction away from the cable—e.g., toward an open end of a conduit—the teeth engage the cable and pull it out of the conduit.

FIG. 6 shows a gripper arrangement 100 formed as two separate pieces 102, 104, similar to the gripper arrangement 90 illustrated and described above. The gripper arrangement 100 includes a plurality of threads 106, which may be cast into the pieces 102, 104; alternatively they may be machined into the pieces 102, 104, or they may be cast as a near-net shape and have minimal machining done to them after the casting process. Also shown in FIG. 6 is a portion of an electrical cable 108, which has been freed from the inside wall of the conduit—for example, by a cutter arrangement such as illustrated and described above—and which has then been gripped by the threads 106 of the gripper arrangement 100 such that it could be extracted from the conduit. As shown in FIG. 6, the internal threads 106 of the gripper arrangement 100 narrow from a first end 109, where they have a thread diameter (d1), to a second end 111, where they have a smaller thread diameter (d2). Similar to the gripper arrangement 90 described above in conjunction with FIG. 5, the first end 109 of the gripper arrangement 100 will be disposed closer to a cutter arrangement than the second end 111.

Referring back to FIG. 1, the process may be accomplished as follows. First, the system 10 would be taken to the site where a problem has been identified. If the conduit can be accessed from inside a building, the system 10 can be at least partially disassembled as described above, taken into the building, and reassembled at the access site. If, however, access to the conduit can only be had at some point underground, an excavation pit can be dug to provide access to the conduit opening. This may still be preferable to digging up the entire conduit and trying to rehabilitate it or replacing it with a new conduit, which requires much more excavation and trenching to accomplish.

Once the conduit is accessed, the motor assembly 56 and tool head 66 are moved linearly inside the conduit, for example, by rotating the handle 74. The motor 62 is then operated to rotate the tool head 66 such that the circumferential cutter 78 cuts through any fused or welded area of the cable and conduit. Then the tool head 66 is further inserted into the conduit by moving the motor assembly 56 and the tool head 66 linearly along the rack 72—see FIG. 2—so that the freed-end of the cable is firmly inserted into the gripper arrangement 90. Once the cable is twisted firmly within the threads of the gripper arrangement, operation of the motor 62 is ceased, and then the cable is linearly extracted by moving the entire motor assembly 56 and tool head 66 out of the conduit, for example, by rotating the handle 74 in a reverse direction.

Although a cutter arrangement and gripper arrangement may be configured to virtually any size effective to perform the tasks described above, in at least some embodiments, the cutter arrangement may be, for example, of a diameter that is just slightly smaller than the inside diameter of the conduit into which it is being inserted. If, for example, the inside diameter of the conduit was approximately 2 inches, the diameter of a corresponding cutter arrangement may be 1.75 inches or even larger to ensure that any fusing or welding of the cable to the inside diameter of the conduit was effectively cut without leaving a significant amount of material along the inside of the conduit.

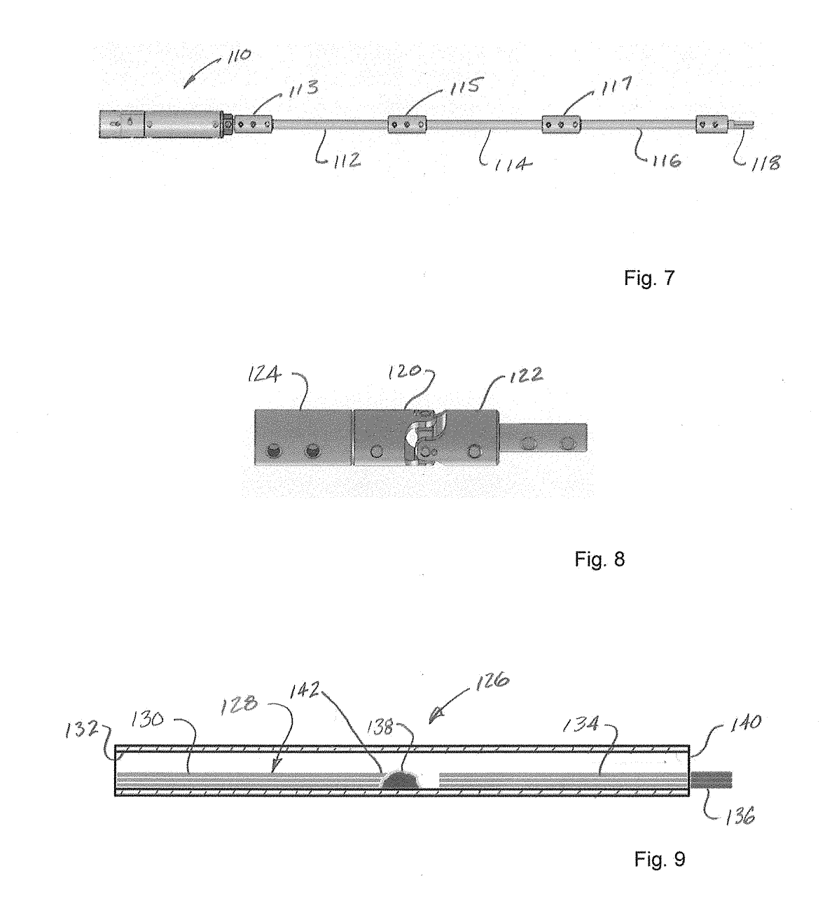

As described above, an electrical cable that has short-circuited inside a conduit may not be easily accessible. In fact, its precise location may not even be known without an inspection prior to the remediation. Therefore, systems and methods in accordance with embodiments described herein may include an inspection camera, which is utilized at an initial stage to locate with some precision the problem site within the conduit. Because it is possible that the welded or fused portion may be at some length within the conduit, and not near the entry point of the conduit, embodiments described herein may include a plurality of extension rods, such as the extension rod 68 illustrated in FIG. 1. FIG. 7 shows a tool head 110 configured similarly to the tool head 66 illustrated and described above. In the embodiment illustrated in FIG. 7, the tool head 110 is attached to three extension rods 112, 114, 116 in series to provide necessary length to reach the fused portion of the electrical cable. Female couplings 113, 115, 117 are attached to the ends of the rods 112, 114, 116, and may be integral with them or attachable through set screws as illustrated in FIG. 7.

At the end of the last extension rod 116 is a shaft 118 configured for attachment to a motor, such as the motor 62. The shaft 118 may be hexagonal, square, or any other geometric configuration that provides good mating with a chuck of the motor assembly. The shaft 118 may also have a Morse taper if the motor assembly includes a chuck that is configured with a female Morse taper. As described in detail above, an angle stand, such as the angle stand 58, may include a mechanism for angular adjustment to allow a tool head, such as the tool head 66, to enter a conduit at an angle that is not precisely horizontal. To provide further flexibility with regard to angular movement, embodiments described herein also contemplate the use of one or more universal joints, such as the universal joint 120 illustrated in FIG. 8. A universal joint, such as the universal joint 120, may be configured with a rod 122 on one end, and a female coupling 124 on the other end, such that it is attachable at either end or in the middle of a number of extension rods, such as the extension rods 112, 114, 116 illustrated in FIG. 7.

FIG. 9 shows a cross section of an electrical conduit 126 that contains an electrical cable 128. As shown in FIG. 9, a first portion 130 of the electrical cable 128 is fused to an inside wall 132 of the conduit 126. A second portion 134 of the electrical cable 128 is not fused to the conduit 126, and this may be a result of an attempt to pull an end 136 of the electrical cable 128 out of the conduit 126. As described above, it is not uncommon for an electrical cable to break in these circumstances. Also shown in FIG. 9 is a mass 138 of welded metal, which may include material from some or all of the conductors in the electrical cable 128, and possibly some of the material of the conduit 126. After the second portion 136 of the cable 128 is removed from the conduit 126, a method described herein may use a circumferential cutter slightly smaller than an inside diameter of the conduit 126 to cut through the mass 138 to disengage the first portion 130 of the cable 128 from the inside wall 132 of the conduit 126. The cutter may be deployed into the conduit 126 through an open end 140, which may be accessed by opening a connection at an electrical meter, or through a small excavation to access a portion of the conduit 126. Once an end 142 of the cable 128 is detached from the conduit 126, a gripper arrangement such as described above may be used to secure the end 142 so that it can be removed from the conduit 126.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for electrical infrastructure maintenance, comprising:
a cutter arrangement configured for insertion into an electrical conduit and operable to cut around at least a portion of an electrical cable disposed within the conduit;
a gripper arrangement operable to capture a portion of the electrical cable; and
a motor arrangement operable to rotate and move linearly the cutter arrangement and to move linearly the gripper arrangement.

2. The system of claim 1, wherein the gripper arrangement is operably connected to the motor arrangement such that the motor arrangement is further operable to rotate the gripper arrangement.

3. The system of claim 2, wherein the gripper arrangement includes a plurality of internal threads having a thread diameter that narrows from a first end to a second end, the first end being disposed closer to the cutter arrangement than the second end to facilitate entry of the electrical cable into the first end of the gripper arrangement.

4. The system of claim 3, wherein the cutter arrangement includes a circumferential cutter having a front portion with cutting teeth disposed around a circumference thereof and a rear portion having an aperture disposed therethrough configured to allow an end of the electrical cable to pass through the aperture and into the gripper arrangement.

5. The system of claim 3, wherein the second end of the gripper arrangement includes an aperture configured to allow an end of the electrical cable to pass therethrough.

6. The system of claim 5, further comprising an extension tube connected to the gripper arrangement and configured to receive the end of the electrical cable through the aperture in the second end of the gripper arrangement.

7. The system of claim 1, further comprising a support structure having the motor arrangement mounted thereon such that the motor arrangement is vertically adjustable on the support structure.

8. A system for electrical infrastructure maintenance, comprising:
a tool head including a rotationally-actuated cutter and a gripper, the tool head being operable to cut around at least a portion of an electrical cable disposed within a conduit, and further operable to secure the electrical cable therein; and
a motor arrangement operable to rotate the tool head for cutting and securing the electrical cable.

9. The system of claim 8, wherein the motor arrangement is further operable to move the tool head linearly.

10. The system of claim 8, wherein the gripper is rotationally-actuated.

11. The system of claim 10, wherein the gripper includes a plurality of internal threads configured to secure the electrical cable therein when the motor arrangement operates to rotate the tool head.

12. The system of claim 11, wherein the gripper includes a first end having a first diameter configured to receive an end of the electrical cable, and a second end having a second diameter smaller than the first diameter.

13. The system of claim 12, wherein the second end of the gripper includes an aperture configured to receive an end of the electrical cable therethrough.

14. The system of claim 13, further comprising an extension tube connected to the gripper and configured to receive the end of the electrical cable through the aperture in the second end of the gripper.

15. The system of claim 13, wherein the cutter includes a front portion with cutting teeth disposed around a circumference thereof and a rear portion having an aperture configured to allow the end of the electrical cable to pass therethrough and into the gripper.

16. A method for electrical infrastructure maintenance, comprising:
cutting around an outside of an electrical cable adhered to an inside wall of a conduit with a cutter arrangement to detach the electrical cable from the inside wall of the conduit;
securing an end of the electrical cable with a gripper arrangement after the electrical cable is detached from the inside wall of the conduit; and
pulling the electrical cable from the conduit after the end of the electrical cable is secured with the gripper arrangement.

17. The method of claim 16, wherein the gripper arrangement forms at least a part of a tool head having a longitudinal axis, and wherein securing an end of the electrical cable with the gripper arrangement includes moving the tool head linearly along the longitudinal axis.

18. The method of claim 17, wherein the cutter arrangement forms at least a part of the tool head.

19. The method of claim 17, wherein securing an end of the electrical cable with the gripper arrangement further includes rotating the tool head around the longitudinal axis.

20. The method of claim 19, wherein the gripper arrangement includes a plurality of internal threads, and securing an end of the electrical cable with the gripper arrangement further includes rotating the tool head around the longitudinal axis such that the end of the electrical cable is secured with the internal threads.
